(19) United States
(12) Patent Application Publication
(10) Pub. No.: US 2018/0286036 A1
(43) Pub. Date: Oct. 4, 2018

(54) OPTICAL ELEMENT AND OPTICAL DEVICE, OPTICAL ELEMENT INSPECTING DEVICE AND OPTICAL DEVICE INSPECTING DEVICE, AND OPTICAL ELEMENT INSPECTING METHOD AND OPTICAL DEVICE INSPECTING METHOD

(71) Applicant: FUJIKURA LTD., Tokyo (JP)

(72) Inventor: Koichiro Iwata, Chiba (JP)

(73) Assignee: FUJIKURA LTD., Tokyo (JP)

(21) Appl. No.: 15/531,665

(22) PCT Filed: Sep. 20, 2016
(86) PCT No.: PCT/JP2016/077655

§ 371 Date: May 30, 2017

(30) Foreign Application Priority Data
Dec. 18, 2015 (JP) 2015-247606

(51) Int. Cl. G06T 7/00; G01N 21/94; H04N 5/225; G02B 1/11

(52) U.S. Cl. CPC G06T 7/0008; G01N 21/94; G06T 2207/10152; G06T 7/001; G02B 1/11; H04N 5/2256

(57) ABSTRACT

An optical device detects the presence or absence of a foreign matter and a position of the foreign matter. The optical device includes first and second antireflection films each provided in an optical window of a lid part covering an opening of a housing part, the first and second antireflection films each (i) transmitting therethrough signal light used by an optical element, (ii) having a higher reflectance with respect to inspecting light than a reflectance with respect to the signal light, the inspecting light being different in wavelength from the signal light, and (iii) having a lower reflectance with respect to second inspecting light than a reflectance with respect to first inspecting light.

### TECHNICAL FIELD

The present invention relates to an optical element using signal light and an optical device including the optical element, an optical element inspecting device and an optical device inspecting device, and an optical element inspecting method and an optical device inspecting method.

### BACKGROUND

FIG. 6 is a vertical cross-sectional view illustrating an arrangement of a conventional optical device. FIG. 7 is a graph showing a relationship between a wavelength of incident light and a reflectance in the optical device illustrated in FIG. 6.

As illustrated in FIG. 6, there is known an optical device 101 that includes therein an optical element 111 and causes signal light to enter the optical element 111 via an optical window. According to the optical device 101, the optical element 111 is fixed to a base of a housing part 112 in a shape of a quadrate container, and the housing part 112 is sealed with a lid part 113 that is joined onto the housing part 112. The signal light enters the optical element 111 via an optical window 113a that is provided in the lid part 113. Such an optical device 101 is disclosed in, for example, Patent Literature 1.

The optical window 113a of the optical device 101 may be provided with antireflection films 115 and 116 for preventing reflection of signal light to be used. As illustrated in FIG. 7, the antireflection films 115 and 116 are each designed without regard to a response to light having a wavelength in a visible light range.

According to the optical device 101, presence or absence of a foreign matter remaining in the optical device 101 is inspected while the lid part 113 is joined to the housing part 112. For the inspection, an inspecting device including an observation optical system is used. The inspecting device determines presence or absence of a foreign matter at a focusing position in the observation optical system.

The observation optical system has a depth of field which depth is determined in accordance with an optical magnification, a numerical aperture (NA), and specifications of an image pickup device. In a case where an object is within the depth of field, the observation optical system clearly captures the object. Meanwhile, as the object is outside the depth of field, a captured image of the object is out of focus, so that the object is out of sight.

According to the inspecting device, the depth of field of the observation optical system has been conventionally adjusted, by being made shallow, so that focusing is achieved in, for example, only an area that is narrower than the optical window 113a. In this case, the observation optical system cannot obtain focusing simultaneously in an outer surface (outside surface) of the optical window 113a and on an inside of the lid part 113. Thus, it can be determined that a foreign matter observed when focusing is achieved by the observation optical system in the outer surface of the optical window 113a is present on an outside of the optical window 113a. Meanwhile, it can be determined that a foreign matter observed when focusing is achieved by the observation optical system in an inner surface (inside surface) of the optical window 113a is present on an inside of the optical window 113a. Further, it can be determined that a foreign matter observed when focusing is achieved by the observation optical system in an outer surface of the optical element 111 is present in the outer surface of the optical element 111. The conventional inspecting device is thus arranged to detect presence or absence of a foreign matter in the optical device 101 and a position of the foreign matter by moving a focusing position in the observation optical system.

Patent Literature 2 discloses a method for sensing a position of a defect in each of (i) a first surface and (ii) a second surface of a transparent plate and (iii) a medium of the transparent plate. According to the method, by causing direct internal lighting to emit light from a side surface of the transparent plate to a defect in the medium of the transparent plate and causing external lighting to emit light at a given angle with respect to a direction normal to the transparent plate, focusing is achieved at a first defocusing position and a second defocusing position, and images are captured at the first defocusing position and the second defocusing position, respectively. Further, according to the method, by comparing signal levels of the defect shown in these images, a vertical position of the defect in the transparent plate (a position of the defect in the direction normal to the transparent plate) is calculated.

### CITATION LIST

### Patent Literatures

[Patent Literature 1]

Japanese Patent Application Publication Tokukai No. 2006-128514 (Publication date: May 18, 2006)

[Patent Literature 2]

Published Japanese Translation of PCT International Application, Tokuhyo, No. 2001-519890 (Publication date: Oct. 23, 2001)

### SUMMARY

According to the conventional inspecting device, the depth of field of the observation optical system is made shallow, and it is determined that a foreign matter observed when focusing is achieved by the observation optical system in the outer surface of the optical window 113a is present on the outside of the optical window 113a. Meanwhile, it is determined that a foreign matter observed when focusing is achieved by the observation optical system in the inner surface of the optical window 113a is present on the inside of the optical window 113a. Further, it is determined that a foreign matter observed when focusing is achieved by the observation optical system in the outer surface of the optical element 111 is present in the outer surface of the optical element 111.

Thus, in a case where presence or absence of a foreign matter in each of the above places is inspected after the lid part 113 is joined to the housing part 112, focusing needs to be accurately achieved by the observation optical system with respect to each observation target surface. Further, every time the observation target surface is changed, it is necessary to adjust the inspecting device and/or a height of the observation target surface in accordance with an adjustment of a focusing position in the observation optical system. Thus, these operations are extremely troublesome. In particular, in a case where the optical window 113a which is transparent is to be observed, it is not easy to achieve focusing in the optical window 113a itself.

A theoretical formula for a depth of field of an observation optical system is as follows: depth of field=diameter of permissible circle of confusion/(NA×optical magnification). It is generally easier to arrange an optical system having a high magnification to have a shallow depth of field. Thus, in a case where a wide area needs to be observed by the observation optical system, the optical device 101, which is to be observed, needs to be repeatedly observed while being moved in a horizontal plane. This requires a long time for observation.

Meanwhile, the arrangement disclosed in Patent Literature 2 has an advantage of measuring a vertical position of a foreign matter by use of two images. Note, however, that the arrangement disclosed in Patent Literature 2 requires two types of lighting to be provided in respective different states. In particular, direct internal lighting needs to be provided by elaborating an object to be inspected. Thus, the arrangement disclosed in Patent Literature 2 is difficult to apply to the optical device 101.

One or more embodiments of the present invention provides an optical element and an optical device each of which easily detects presence of a foreign matter and a position of the foreign matter, an optical element inspecting device and an optical device inspecting device, and an optical element inspecting method and an optical device inspecting method.

An optical device of one or more embodiments of the present invention includes: a housing part; an optical element contained in the housing part; a lid part having an optical window and covering an opening of the housing part; and a first antireflection film provided in the optical window, the first antireflection film (i) transmitting therethrough signal light used by the optical element, (ii) having a higher reflectance with respect to inspecting light than a reflectance with respect to the signal light, the inspecting light being different in wavelength from the signal light, and (iii) having a lower reflectance with respect to second inspecting light than a reflectance with respect to first inspecting light, the first inspecting light and the second inspecting light each serving as the inspecting light.

### Advantageous Effects of Invention

The arrangement of one or more embodiments of the present invention makes it easy for an optical device and an optical element to detect presence of a foreign matter and a position of the foreign matter.

### BRIEF DESCRIPTION OF DRAWINGS

FIG. 1 is a block diagram illustrating an inspecting device of an embodiment of the present invention.

(a) of FIG. 2 is a vertical cross-sectional view of an optical device illustrated in FIG. 1. (b) of FIG. 2 is an explanatory diagram illustrating a foreign matter that is photographed by a camera of FIG. 1 in a case where the optical device of (a) of FIG. 2 is irradiated with red light from an upper surface thereof. (c) of FIG. 2 is an explanatory diagram illustrating a foreign matter that is photographed by the camera of FIG. 1 in a case where the optical device (a) of FIG. 2 is irradiated with blue light from the upper surface thereof.

FIG. 3 is a graph showing a relationship between a wavelength of incident light and a reflectance in the optical device illustrated in (a) of FIG. 2.

FIG. 4 is a vertical cross-sectional view of an optical device of another embodiment of the present invention.

FIG. 5 is a graph showing a relationship between a wavelength of incident light and a reflectance in the optical device illustrated in FIG. 4.

FIG. 6 is a vertical cross-sectional view illustrating an arrangement of a conventional optical device.

FIG. 7 a graph showing a relationship between a wavelength of incident light and a reflectance in the optical device illustrated in FIG. 6.

### DESCRIPTION OF EMBODIMENTS

### Embodiment 1

An embodiment of the present invention is described below with reference to the drawings.

(Arrangement of Inspecting Device 1)

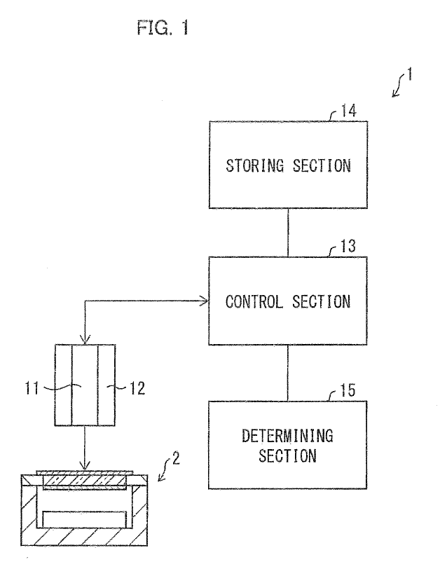

FIG. 1 is a block diagram illustrating an inspecting device of Embodiment 1 As illustrated in FIG. 1, the inspecting device 1 includes a camera (photographing section) 11, an illumination device (illumination section) 12, a control section 13, a storing section 14, and a determining section 15.

The camera 11 is a conventionally known image pickup device and is, for example, a CCD camera. The camera 11 photographs the optical device 2 from the optical device 2 upper surface side so as to obtain an image (image data) of the optical device 2. The obtained image is stored in the storing section 14. In this case, the camera 11 obtains respective images of the optical device 2 of a plurality of colors of light emitted from the illumination device 12.

For example, the illumination device 12 is provided in a shape of a ring so as to surround the camera 11. The illumination device 12 includes LED lighting of a plurality of colors, and a color of lighting that emits light with which the optical device 2, which is an object to be photographed, is irradiated can be selected in each case. According to Embodiment 1, the illumination device 12 can emit red light (first visible light (first inspecting light)) and blue light (second visible light (second inspecting light)).

The control section 13 controls each section of the inspecting device 1 and causes the storing section 14 to store the images of optical device 2 which images have been obtained by the camera 11. The storing section 14 is, for example, a storage device constituted by a semiconductor memory.

The determining section 15 compares the images of the optical device 2, which images are stored in the storing section 14, and finds presence or absence of a foreign matter in the optical device 2, a position of the foreign matter which is present (where in the optical device 2 the foreign matter is present), and a size and a shape of the foreign matter.

(Arrangement of Optical Device 2)

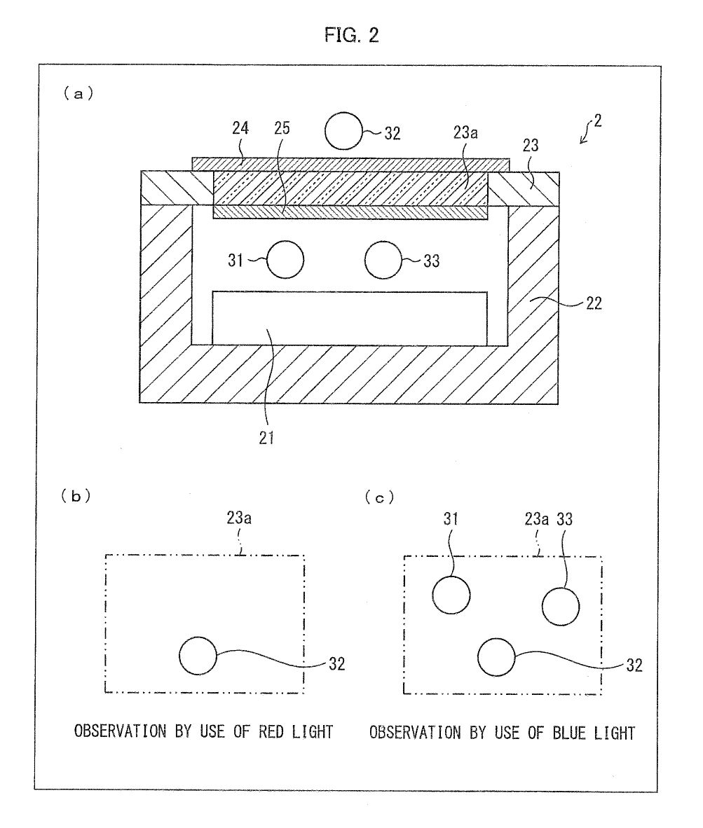

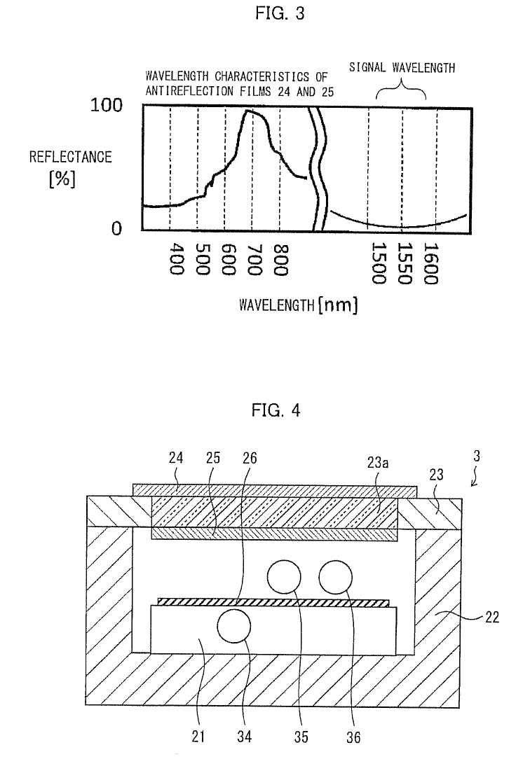

(a) of FIG. 2 is a vertical cross-sectional view of the optical device 2 illustrated in FIG. 1. (b) of FIG. 2 is an explanatory diagram illustrating a foreign matter that is photographed by the camera 11 of FIG. 1 in a case where the optical device 2 is irradiated with the red light from the upper surface thereof. (c) of FIG. 2 is an explanatory diagram illustrating a foreign matter that is photographed by the camera 11 of FIG. 1 in a case where the optical device 2 is irradiated with the blue light from the upper surface thereof. FIG. 3 is a graph showing a relationship between a wavelength of incident light and a reflectance in the optical device 2.

As illustrated in (a) of FIG. 2, according to the optical device 2, an optical element 21 is fixed to a base of the housing part 22 in, for example, a shape of a quadrate container. Onto the housing part 22, a lid part 23 is joined. With the lid part 23, an inside of the optical device 2 is sealed. The lid part 23 is provided with an optical window 23a through which light to enter the optical element 21 is transmitted.

The optical window 23a has an upper surface that is provided with a window part antireflection film (first antireflection film) 24 and a lower surface that is provided with a window part antireflection film (first antireflection film) 25. The window part antireflection films 24 and 25 have a low reflectance with respect to signal light (light having a first wavelength) used by the optical device 2 and have a high reflectance with respect to visible light (inspecting light).

According to Embodiment 1, the signal light is, for example, light having a wavelength of approximately 1550 nm. As the visible light, the first visible light (first inspecting light) and the second visible light (second inspecting light) are used. The first visible light is the red light having a wavelength of approximately 770 nm. The second visible light is the blue light having a wavelength of approximately 450 nm. Thus, the window part antireflection films 24 and 25 of the optical device 2 have wavelength characteristics that are summarized as below.

Signal light: (e.g.,) light having a wavelength of approximately 1550 nm, being low in reflectance, and transmitted through the window part antireflection films 24 and 25 (entering the inside of the optical device 2)

Red light: first visible light (first inspecting light), (e.g.,) light having a wavelength of approximately 770 nm and reflected by the window part antireflection films 24 and 25

Blue light: second visible light (second inspecting light), (e.g.,) light having a wavelength of approximately 450 nm and transmitted through the window part antireflection films 24 and 25

Note that the window part antireflection films 24 and 25 specifically have, for example, a reflectance of not more than 1% with respect to the signal light and a reflectance of not less than 80% with respect to the red light (first inspecting light), and a reflectance of not more than 40% with respect to the blue light (second inspecting light).

Embodiment 1 is arranged such that the window part antireflection films 24 and 25 are identical in characteristic. Note, however, that the window part antireflection film 24 may have a higher reflectance with respect to visible light than the window part antireflection film 25. Note also that the signal light only needs to have a wavelength that is not limited to 1550 nm and is a wavelength of signal light that is actually used in the optical device 2. Further, it is only necessary that only one of the window part antireflection films 24 and 25, both of which are necessary, has reflection characteristics with respect to the red light (first inspecting light) and the blue light (second inspecting light).

The following description discusses a process for manufacturing the optical device 2 having the arrangement, the process including a step of causing the inspecting device 1 to inspect the optical device 2 (a foreign matter inspecting step).

(Process for Manufacturing Optical Device 2)

The process for manufacturing the optical device 2 is carried out in a state in which the optical element 21 is fixed to the base of the housing part 22. In this state, the lid part 23 is provided on the housing part 22, and the inspecting device 1 inspects presence or absence of a foreign matter in the optical device 2 before the optical device 2 is sealed by joining the lid part 23 to the housing part 22.

As a result of the inspection by the inspecting device 1, in a case where no foreign matter is present in the optical device 2, the optical device 2 is sealed by joining the lid part 23 to the housing part 22. Meanwhile, in a case where a foreign matter is present in the optical device 2, the lid part 23 is detached from the housing part 22, the foreign matter is removed by cleaning the inside of the optical device 2, and thereafter the optical device 2 is sealed by joining the lid part 23 to the housing part 22. Note that after the inside of the optical device 2 is cleaned, the inspection by the inspecting device 1 may be carried out again before the lid part 23 is joined to the housing part 22.

A foreign matter that is present on the lid part 23 does not matter here. This is because such a foreign matter can be removed later. That is, it is only necessary to detect a foreign matter attached to an inner surface of the optical window 23a and a foreign matter attached to an upper surface, i.e., an entrance surface of the optical element 21.

(Step of Inspecting Optical Device 2)

An optical system of the inspecting device 1, i.e., the camera 11 is set to have a great depth of field and is arranged to be capable of taking a photograph while achieving a state of focusing from an outer surface of the optical window 23a to the entrance surface of the optical element 21. A range of photographing by the camera 11 desirably includes a whole area of the optical window 23a. Note, however, that in a case where the camera 11 can photograph only an area that is narrower than the optical window 23a, the whole area of the optical window 23a is photographed by repeatedly photographing the optical device 2 by moving the camera 11 or the optical device 2.

In the inspection, after a positional relationship between the camera 11 and the optical device 2 is adjusted, the red light (first inspecting light) is emitted from the illumination device 12 to the optical device 2 first, and the optical device 2 is photographed by the camera 11 so as to obtain a first image. The control section 13 stores the first image in the storing section 14.

Next, while none of positions (e.g., a position of the inspecting device 1, a position of the optical device 2, etc.) are changed, the blue light (second inspecting light) is emitted from the illumination device 12 to the optical device 2, and the optical device 2 is photographed by the camera 11 so as to obtain a second image. The control section 13 stores the second image in the storing section 14. Note that either one of the first image obtained by the emission of the red light and the second image obtained by the emission of the blue light may be obtained earlier than the other.

Subsequently, the determining section 15 compares the first image and the second image, which are stored in the storing section 14, and finds presence or absence of a foreign matter in the optical device 2, and a size and a shape of the foreign matter which is present in the optical device 2.

In this case, the red light is reflected by the window part antireflection film 24. Meanwhile, the blue light is transmitted through the window part antireflection film 24 and the window part antireflection film 25, so that a surface of the optical element 21 is irradiated with the blue light. Thus, as illustrated in (a) of FIG. 2, in a case where foreign matters 31 and 33 are present in the optical device and a foreign matter 32a is present in the outer surface of the optical window 23a (the upper surface of the optical device 2), only the foreign matter 32 is shown in the first image obtained by the emission of the red light (see (b) of FIG. 2).

Meanwhile, the foreign matters 31 through 33 are shown in the second image obtained by the emission of the blue light (see (b) of FIG. 2).

Under the circumstances, the determining section 15 obtains a difference image (difference image data) by carrying out calculation to subtract the first image (first image data) from the second image (second image data). In the examples shown in (a) through (c) of FIG. 2, since the foreign matters 31 and 33 are shown in the difference image, the determining section 15 determines that a foreign matter is present in the optical device 2. Meanwhile, in a case where no foreign matter is shown in the difference image, the determining section 15 determines that no foreign matter is present in the optical device 2. Further, in a case where a foreign matter is present in the optical device 2, the determining section 15 finds a size and a shape of the foreign matter from coordinates of the foreign matter. The inspecting device 1 outputs a result of the determination by the determining section 15 as a result of detection of a foreign matter.

(Advantage of Inspecting Device 1)

According to the inspecting device 1 of Embodiment 1, without the need to change a focal position of the camera 11 in accordance with the optical device 2 to be inspected, it is possible to detect presence or absence of a foreign matter from the outer surface of the optical window 23a of the optical device 2 to the entrance surface of the optical element 21, This allows a simpler arrangement of the inspecting device 1 for inspection of presence or absence of a foreign matter in the optical device 2 and allows a reduction in time required for the inspection.

For presence or absence of a foreign matter from the outer surface of the optical window 23a of the optical device 2 to the entrance surface of the optical element 21, a foreign matter can be observed by the camera 11 while focusing is achieved therein, and thus a size and a shape of the foreign matter can be detected with high accuracy from an image of the optical device 2 which image is obtained by the camera 11.

Note here that a case where a foreign matter is detected is actually separated, in accordance with a size and a shape of the foreign matter, into the following cases: (i) a case where presence of the foreign matter does not matter; and (i) a case where presence of the foreign matter matters and the foreign matter needs to be removed. Examples of such a case include a case where the foreign matter whose long side (longer side) has a length that is not less than a predetermined threshold (not less than A mm) is considered to be improper and the foreign matter whose long side (longer side) has a length that is less than the predetermined threshold (less than A mm) is considered to be proper. Thus, detection of a size and a shape of the foreign matter by use of an optical system having a great depth of field makes it possible to meet the above circumstances.

Note that the inspecting device 1 is arranged such that the illumination device 12 emits the red light (first visible light (first inspecting light)) and the blue light (second visible light (second inspecting light)) to the optical device 2, and the window part antireflection films 24 and 25 have a high reflectance with respect to visible light and have a lower reflectance with respect to the blue light than a reflectance with respect to the red light. Note, however, that the inspecting light (first inspecting light and second inspecting light) emitted by the illumination device 12 to the optical device 2 is not limited to the red light and the blue light. Specifically, the inspecting light (first inspecting light and second inspecting light) only needs to be arranged such that the inspecting light has a wavelength different from a wavelength of the signal light, the first inspecting light is high in reflectance of the window part antireflection films 24 and 25, and the second inspecting light is low in reflectance of the window part antireflection films 24 and 25. In this case, the reflectance of the window part antireflection films 24 and 25 may be set in accordance with the first inspecting light and the second inspecting light.

Since the illumination device 12 easily glares in an image that is captured by the camera 11, light of the illumination device 12 may also be arranged to be emitted to the optical device 2 via a diffuser.

### Embodiment 2

Another embodiment of the present invention is described below with reference to the drawings.

(Arrangement of Inspecting Device 1)

According to Embodiment 2, an illumination device 12 includes LED lighting of a plurality of colors and emits not only red light (first visible light (first inspecting light)) and blue light (second visible light (second inspecting light)) but also green light (third visible light (third inspecting light)) to an optical device 3. The green light is light having a wavelength of approximately 530 nm.

In response to the first inspecting light through the third inspecting light, a camera 11 obtains not only a first image derived from the red light and a second image derived from the blue light but also a third image derived from the green light. A determining section 15 compares the first through third images of the optical device 3, which images are stored in a storing section 14, and finds presence or absence of a foreign matter in the optical device 3, a position of the foreign matter which is present (where in the optical device 3 the foreign matter is present), and a size and a shape of the foreign matter.

(Arrangement of Optical Device 3)

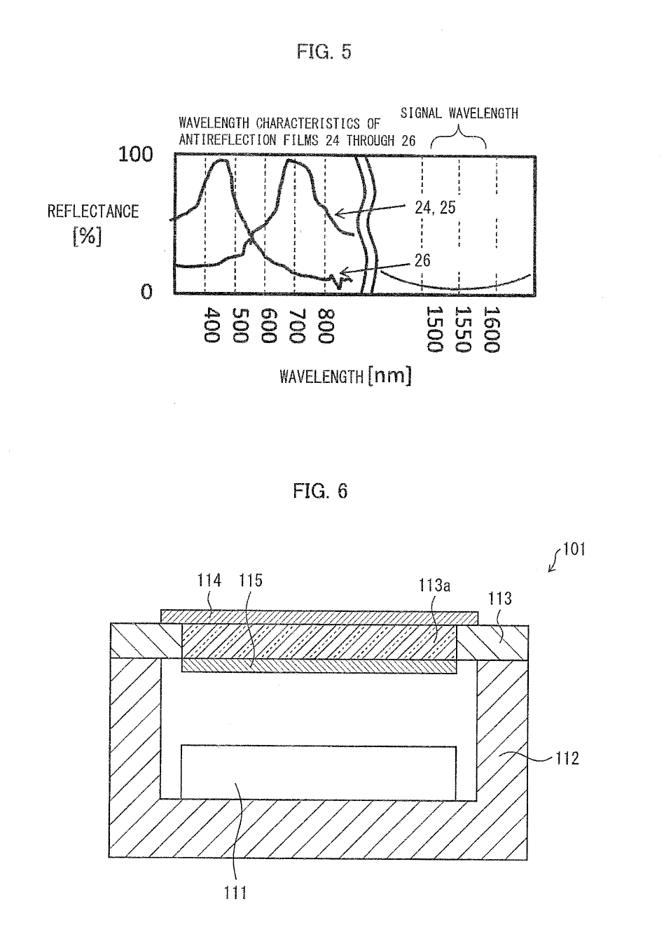

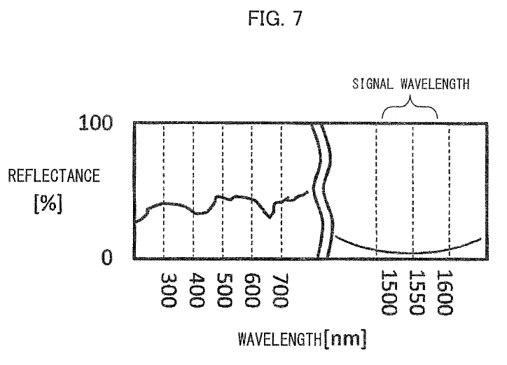

FIG. 4 is a vertical cross-sectional view of the optical device 3 of Embodiment 2. FIG. 5 is a graph showing a relationship between a wavelength of incident light and a reflectance in the optical device 3.

The optical device 3 includes not only the window part antireflection films 24 and 25 included in the optical device 2 but also an element part antireflection film (second antireflection film) 26. The element part antireflection film 26 is provided on an entrance surface of an optical element 21. As described above, the optical element 21 which is, for example, a photodetector (PD) or a liquid crystal optical switch element (Liquid crystal on silicon (LCOS)) may have an antireflection film on the entrance surface thereof. The other arrangements of the optical device 3 are identical to those of the optical device 2.

The element part antireflection film 26 reflects the red light (first visible light (first inspecting light)) and the blue light (second visible light (second inspecting light)), and transmits therethrough signal light and the green light (third visible light (third inspecting light)). Thus, the window part antireflection films 24 and 25 and the element part antireflection film 26 each included in the optical device 3 have the following wavelength characteristics.

Signal light: (e.g.,) light having a wavelength of approximately 1550 nm, being low in reflectance, and transmitted through the window part antireflection films 24 and 25, and the element part antireflection film 26 (entering an inside of the optical device 3)

Red light: first visible light (first inspecting light), (e.g.,) light having a wavelength of approximately 770 nm and reflected by the window part antireflection films 24 and 25

Blue light: second visible light (second inspecting light), (e.g.,) light having a wavelength of approximately 450 nm, transmitted through the window part antireflection films 24 and 25, and reflected by the element part antireflection film 26

Green light: third visible light (third inspecting light), (e.g.,) light having a wavelength of approximately 530 nm and transmitted through the window part antireflection films 24 and 25, and the element part antireflection film 26 (entering an inside of the optical element 21)

Note that the window part antireflection films 24 and 25 specifically have, for example, a reflectance of not more than 1% with respect to the signal light and a reflectance of not less than 80% with respect to the red light (first inspecting light), and a reflectance of not more than 40% with respect to the blue light (second inspecting light). Note also that the element part antireflection film 26 specifically has, for example, a reflectance of not less than 80% with respect to the blue light and a reflectance of not more than 40% with respect to the green light.

(Step of Inspecting Optical Device 3)

The following description discusses an inspection step (foreign matter inspecting step) carried out by an inspecting device 1 with respect to the optical device 3 having the arrangement.

As in the case of the optical device 2, the inspecting device 1 finds presence or absence of a foreign matter in the optical device 3 and a size and a shape of the foreign matter which is present in the optical device 3.

Since the blue light (second inspecting light) is reflected by the element part antireflection film 26 provided on the entrance surface of the optical element 21, the inside of the optical element 21 cannot be observed in a case where the optical device 3 is photographed while the blue light is being emitted thereto. In view of this, according to Embodiment 2, the inspecting device 1 emits the green light (third inspecting light) and causes the camera 11 to photograph the optical device 3 so as to obtain a third image of the optical device 3 (image of the inside of the optical element 21). A control section 13 stores the third image in the storing section 14.

Subsequently, the determining section 15 compares the second image and the third image, which are stored in the storing section 14, and finds presence or absence of a foreign matter in the optical element 21.

In this case, as illustrated in FIG. 4, in a case where foreign matters 35 and 36 are present in the entrance surface of the optical element 21, the foreign matters 35 and 36 are shown in the second image obtained by the emission of the blue light. Meanwhile, in a case where a foreign matter 34 is present in the optical element 21, foreign matters 34 through 36 are shown in the third image obtained by the emission of the green light.

Under the circumstances, the determining section 15 obtains a second difference image (difference image data) by carrying out calculation to subtract the second image (second image data) from the third image (third image data). In the example shown in FIG. 4, since the foreign matter 34 is shown in the second difference image, the determining section 15 determines that a foreign matter is present in the optical element 21. Meanwhile, in a case where no foreign matter is shown in the second difference image, the determining section 15 determines that no foreign matter is present in the optical element 21. Further, in a case where a foreign matter is present in the optical element 21, the determining section 15 finds a size and a shape of the foreign matter from coordinates of the foreign matter. The inspecting device 1 outputs a result of the determination by the determining section 15 as a result of detection of a foreign matter.

(Advantage of Inspecting Device 1)

According to the inspecting device 1 of Embodiment 2, it is possible to inspect not only presence or absence of a foreign matter in the optical device 3 but also presence or absence of a foreign matter in the optical element 21. The other advantages of the optical device 3 are identical to those of the optical device 2.

Note that according to Embodiment 2, presence or absence of a foreign matter in the optical element 21 is inspected while the optical element 21 is contained in the optical device 2. Note, however, that presence or absence of a foreign matter in the optical element 21 may be determined from two images of the optical element 21, which two images are, in the present paragraph, the first image and the second image, in a state in which the optical element 21 has not been contained in the optical device 2. The first image is obtained by photographing the optical element 21 by causing the illumination device 12 to emit the blue light (in the present paragraph, the first inspecting light) directly to the optical element 21, and the second image is obtained by photographing the optical element 21 by causing the illumination device 12 to emit the green light (in the present paragraph, the second inspecting light) directly to the optical element 21. An inspecting method carried out in this case is identical to that carried out with respect to each of the optical devices 2 and 3. Further, the present paragraph discusses a method for sensing a foreign matter in the optical element 21 by comparison between images. Note, however, that in order to inspect presence of less abnormality in the optical element 21 than in a normal product, it is possible to solely use the third image obtained by the emission of the third inspecting light.

### Conclusion

An optical device of one or more embodiments of the present invention includes: a housing part; an optical element contained in the housing part; a lid part having an optical window and covering an opening of the housing part; and a first antireflection film provided in the optical window, the first antireflection film (i) transmitting therethrough signal light used by the optical element, (ii) having a higher reflectance with respect to inspecting light than a reflectance with respect to the signal light, the inspecting light being different in wavelength from the signal light, and (iii) having a lower reflectance with respect to second inspecting light than a reflectance with respect to first inspecting light, the first inspecting light and the second inspecting light each serving as the inspecting light.

With the arrangement, the first antireflection film provided in the optical window (i) transmits therethrough signal light used by the optical element, (ii) has a higher reflectance with respect to each of first inspecting light and second inspecting light than a reflectance with respect to the signal light, the first inspecting light and the second inspecting light each being different in wavelength from the signal light, and (iii) has a lower reflectance with respect to the second inspecting light than a reflectance with respect to the first inspecting light.

Thus, it is possible to detect presence or absence of a foreign matter in the optical device by observing the optical device by irradiating the optical device with the first inspecting light and the second inspecting light.

Specifically, by setting the first inspecting light to have, for example, a wavelength that allows the first inspecting light to be substantially reflected by the first antireflection film, and setting the second inspecting light to have, for example, a wavelength that allows the second inspecting light to be substantially transmitted through the first antireflection film, in a case where foreign matters are present on an outside of the optical device (in an upper surface of the optical window or above the optical window) and an inside of the optical device, respectively, the foreign matter which is present on the outside of the optical device is shown in a first image of the optical device which first image is captured by irradiating the optical device with the first inspecting light, and the foreign matter which is present on the inside of the optical device is not shown in the first image. Meanwhile, the foreign matters which are present on the outside of the optical device and the inside of the optical device, respectively, are shown in a second image of the optical device which second image is captured by irradiating the optical device with the second inspecting light.

Thus, in a case where a first difference image in which the first image is subtracted from the second image is obtained, only the foreign matter which is present on the inside of the optical device is shown in the first difference image. This makes it possible to inspect presence or absence of a foreign matter in the optical device.

The optical device may be arranged such that the first antireflection film has a reflectance of not more than 1% with respect to the signal light, a reflectance of not less than 80% with respect to the first inspecting light, and a reflectance of not more than 40% with respect to the second inspecting light.

With the arrangement, the reflectances of the first antireflection film with respect to the signal light, the first inspecting light, and the second inspecting light, respectively, are suitable in terms of (i) operation of the optical element in accordance with the signal light and (ii) inspection of presence or absence of a foreign matter in the optical device in accordance with the first inspecting light and the second inspecting light.

The optical device may be arranged to further include: a second antireflection film provided in an entrance surface of the optical element via which entrance surface the signal light enters the optical element, the second antireflection film having a lower reflectance with respect to third inspecting light than the reflectance with respect to the second inspecting light, the third inspecting light serving as the inspecting light.

With the arrangement, the second antireflection film provided in the entrance surface of the optical element via which entrance surface the signal light enters the optical element has a lower reflectance with respect to the third inspecting light than the reflectance with respect to the second inspecting light. Thus, by observing the optical device by irradiating the optical device with the second inspecting light and the third inspecting light, it is possible to inspect presence or absence of a foreign matter in the optical element contained in the optical device.

Specifically, by setting the second inspecting light to have, for example, a wavelength that allows the second inspecting light to be substantially transmitted through the first antireflection film and allows the second inspecting light to be substantially reflected by the second antireflection film, and setting the third inspecting light to have, for example, a wavelength that allows the third inspecting light to be substantially transmitted through the second antireflection film, in a case where foreign matters are present on an outside of the optical element (in an upper surface of the entrance surface of the optical element or above the entrance surface) and an inside of the optical element, respectively, foreign matters which are present on the outside of the optical device and the inside of the optical device (the outside of the optical element), respectively, are shown in the second image of the optical device which second image is captured by irradiating the optical device with the second inspecting light, and the foreign matter which is present on the inside of the optical element is not shown in the second image. Meanwhile, the foreign matters which are present on the outside of the optical device and the inside of the optical device (the outside of the optical element), respectively, and the foreign matter which is present on the inside of the optical element are shown in a third image of the optical device which third image is captured by irradiating the optical device with the third inspecting light.

Thus, in a case where a second difference image in which the second image is subtracted from the third image is obtained, only the foreign matter which is present on the inside of the optical element is shown in the second difference image. This makes it possible to further inspect presence or absence of a foreign matter in the optical element.

The optical device may be arranged such that: the first antireflection film has a reflectance of not more than 1% with respect to the signal light, a reflectance of not less than 80% with respect to the first inspecting light, and a reflectance of not more than 40% with respect to each of the second inspecting light and the third inspecting light; and the second antireflection film has a reflectance of not more than 1% with respect to the signal light, a reflectance of not less than 80% with respect to the second inspecting light, and a reflectance of not more than 40% with respect to the third inspecting light.

With the arrangement, the reflectances of each of the first antireflection film and the second antireflection film with respect to the signal light, the first inspecting light through the third inspecting light, respectively, are suitable in terms of (i) operation of the optical element in accordance with the signal light, inspection of presence or absence of a foreign matter in the optical device in accordance with the first inspecting light and the second inspecting light, and (iii) inspection of presence or absence of a foreign matter in the optical element in accordance with the second inspecting light and the third inspecting light.

An optical element of one or more embodiments of the present invention is an optical element having an entrance surface via which signal light enters the optical element, the optical element including: an antireflection film provided in the entrance surface, the antireflection film (i) transmitting therethrough signal light, (ii) having a higher reflectance with respect to inspecting light than a reflectance with respect to the signal light, the inspecting light being different in wavelength from the signal light, and (iii) having a lower reflectance with respect to second inspecting light than a reflectance with respect to first inspecting light, the first inspecting light and the second inspecting light each serving as the inspecting light.

With the arrangement, the antireflection film provided in the entrance surface (i) transmits therethrough signal light, (ii) has a higher reflectance with respect to each of first inspecting light and second inspecting light than a reflectance with respect to the signal light, the first inspecting light and the second inspecting light each being different in wavelength from the signal light, and (iii) has a lower reflectance with respect to the second inspecting light than a reflectance with respect to the first inspecting light.

Thus, it is possible to detect presence or absence of a foreign matter in the optical element by observing the optical element by irradiating the optical element with the first inspecting light and the second inspecting light.

Specifically, by setting the first inspecting light to have, for example, a wavelength that allows the first inspecting light to be substantially reflected by the first antireflection film, and setting the second inspecting light to have, for example, a wavelength that allows the second inspecting light to be substantially transmitted through the first antireflection film, in a case where foreign matters are present on an outside of the optical element (in an upper surface of the entrance surface or above the entrance surface) and an inside of the optical element, respectively, the foreign matter which is present on the outside of the optical element is shown in a first image of the optical element which first image is captured by irradiating the optical element with the first inspecting light, and the foreign matter which is present on the inside of the optical element is not shown in the first image. Meanwhile, the foreign matters which are present on the outside of the optical element and the inside of the optical element, respectively, are shown in a second image of the optical element which second image is captured by irradiating the optical element with the second inspecting light.

Thus, in a case where a first difference image in which the first image is subtracted from the second image is obtained, only the foreign matter which is present on the inside of the optical element is shown in the first difference image. This makes it possible to inspect presence or absence of a foreign matter in the optical element.

The optical element may be arranged such that the antireflection film has a reflectance of not more than 1% with respect to the signal light, a reflectance of not less than 80% with respect to the first inspecting light, and a reflectance of not more than 40% with respect to the second inspecting light.

With the arrangement, the reflectances of the antireflection film with respect to the signal light, the first inspecting light, and the second inspecting light, respectively, are suitable in terms of (i) operation of the optical element in accordance with the signal light and (ii) inspection of presence or absence of a foreign matter in the optical element in accordance with the first inspecting light and the second inspecting light.

An optical device inspecting device of one or more embodiments of the present invention includes: an illumination section for emitting first inspecting light and second inspecting light to an inside of an optical device recited in claim 1 or 2 via an optical window of the optical device; a photographing section for (i) photographing the optical device while facing the optical window, (ii) obtaining a first image by photographing the optical device which is being irradiated with the first inspecting light, and (iii) obtaining a second image by photographing the optical device which is being irradiated with the second inspecting light; a storing section for storing the first image and the second image; and a determining section for determining, from the first image and the second image, presence or absence of a foreign matter in the optical device.

With the arrangement, the photographing section (i) photographs the optical device while facing the optical window, (ii) obtains a first image by photographing the optical device which is being irradiated with the first inspecting light, and (iii) obtains a second image by photographing the optical device which is being irradiated with the second inspecting light. The determining section determines, from the first image and the second image, presence or absence of a foreign matter in the optical device.

Specifically, by setting the first inspecting light to have, for example, a wavelength that allows the first inspecting light to be substantially reflected by the first antireflection film, and setting the second inspecting light to have, for example, a wavelength that allows the second inspecting light to be substantially transmitted through the first antireflection film, in a case where foreign matters are present on an outside of the optical device (in an upper surface of the optical window or above the optical window) and an inside of the optical device, respectively, the foreign matter which is present on the outside of the optical device is shown in a first image of the optical device which first image is captured by irradiating the optical device with the first inspecting light, and the foreign matter which is present on the inside of the optical device is not shown in the first image. Meanwhile, the foreign matters which are present on the outside of the optical device and the inside of the optical device, respectively, are shown in a second image of the optical device which second image is captured by irradiating the optical device with the second inspecting light.

Thus, in a case where a first difference image in which the first image is subtracted from the second image is obtained, only the foreign matter which is present on the inside of the optical device is shown in the first difference image. This makes it possible to inspect presence or absence of a foreign matter in the optical device.

An optical device inspecting device of one or more embodiments of the present invention includes: an illumination section for emitting first inspecting light and second inspecting light to an inside of an optical device recited in claim 3 or 4 via an optical window of the optical device; a photographing section for (i) photographing the optical device while facing the optical window, (ii) obtaining a first image by photographing the optical device which is being irradiated with the first inspecting light, and (iii) obtaining a second image by photographing the optical device which is being irradiated with the second inspecting light; a storing section for storing the first image and the second image; and a determining section for determining, from the first image and the second image, presence or absence of a foreign matter in the optical device.

With the arrangement, the photographing section (i) photographs the optical device while facing the optical window, GO obtains a first image by photographing the optical device which is being irradiated with the first inspecting light, and (iii) obtains a second image by photographing the optical device which is being irradiated with the second inspecting light. The determining section determines, from the first image and the second image, presence or absence of a foreign matter in the optical device.

Specifically, the first inspecting light is set to have, for example, a wavelength that allows the first inspecting light to be substantially reflected by the first antireflection film, and the second inspecting light is set to have, for example, a wavelength that allows the second inspecting light to be substantially transmitted through the first antireflection film and allows the second inspecting light to be substantially reflected by the second antireflection film. With this, in a case where foreign matters are present on an outside of the optical device (in an upper surface of the optical window or above the optical window) and an inside of the optical device, respectively, the foreign matter which is present on the outside of the optical device is shown in a first image of the optical device which first image is captured by irradiating the optical device with the first inspecting light, and the foreign matter which is present on the inside of the optical device is not shown in the first image. Meanwhile, the foreign matters which are present on the outside of the optical device and the inside of the optical device (an outside of an optical element), respectively, are shown in a second image of the optical device which second image is captured by irradiating the optical device with the second inspecting light, and a foreign matter which is present on an inside of the optical element is not shown in the second image.

Thus, in a case where a first difference image in which the first image is subtracted from the second image is obtained, only the foreign matter which is present on the inside of the optical device is shown in the first difference image. This makes it possible to inspect presence or absence of a foreign matter in the optical device with higher accuracy.

An optical device inspecting device of one or more embodiments of the present invention includes: an illumination section for emitting first inspecting light, second inspecting light, and third inspecting light to an inside of an optical device recited in claim 3 or 4 via an optical window of the optical device; a photographing section for (i) photographing the optical device while facing the optical window, (ii) obtaining a first image by photographing the optical device which is being irradiated with the first inspecting light, (iii) obtaining a second image by photographing the optical device which is being irradiated with the second inspecting light, and (iv) obtaining a third image by photographing the optical device which is being irradiated with the third inspecting light; a storing section for storing the first through third images; and a determining section for determining, from the first image and the second image, presence or absence of a foreign matter in the optical device, and determining, from the second image and the third image, presence or absence of a foreign matter in the optical device.

With the arrangement, the photographing section (i) photographs the optical device while facing the optical window, (ii) obtains a first image by photographing the optical device which is being irradiated with the first inspecting light, (iii) obtains a second image by photographing the optical device which is being irradiated with the second inspecting light, and (iv) obtains a third image by photographing the optical device which is being irradiated with the third inspecting light. The determining section determines, from the first image and the second image, presence or absence of a foreign matter in the optical device, and determines, from the second image and the third image, presence or absence of a foreign matter in the optical device.

Specifically, the first inspecting light is set to have, for example, a wavelength that allows the first inspecting light to be substantially reflected by the first antireflection film, the second inspecting light is set to have, for example, a wavelength that allows the second inspecting light to be substantially transmitted through the first antireflection film and allows the second inspecting light to be substantially reflected by the second antireflection film, and the third inspecting light is set to have, for example, a wavelength that allows the third inspecting light to be substantially transmitted through the second antireflection film. With this, in a case where foreign matters are present on an outside of the optical device (in an upper surface of the optical window or above the optical window) and an inside of the optical device, respectively, the foreign matter which is present on the outside of the optical device is shown in a first image of the optical device which first image is captured by irradiating the optical device with the first inspecting light, and the foreign matter which is present on the inside of the optical device is not shown in the first image. Meanwhile, in a case where foreign matters are present on an outside of an optical element (in an upper surface of an entrance surface of the optical element or above the entrance surface) and an inside of the optical element, respectively, the foreign matters which are present on the outside of the optical device and the inside of the optical device (the outside of the optical element), respectively, are shown in a second image of the optical device which second image is captured by irradiating the optical device with the second inspecting light, and the foreign matter which is present on the inside of the optical element is not shown in the second image. Meanwhile, the foreign matters which are present on the outside of the optical device, the inside of the optical device (the outside of the optical element), and the inside of the optical element, respectively, are shown in a third image of the optical device which third image is captured by irradiating the optical device with the third inspecting light.

Thus, in a case where a first difference image in which the first image is subtracted from the second image is obtained, only the foreign matter which is present on the inside of the optical device is shown in the first difference image. Meanwhile, in a case where a second difference image in which the second image is subtracted from the third image is obtained, only the foreign matter which is present on the inside of the optical element is shown in the second difference image. This makes it possible to inspect presence or absence of a foreign matter in the optical device and presence or absence of a foreign matter in the optical element.

The optical device inspecting device may be arranged such that the inspecting light is visible light.

With the arrangement, since the inspecting light is visible light, the illumination section can be easily arranged by use of a versatile light source.

An optical element inspecting device of one or more embodiments of the present invention includes: an illumination section for emitting first inspecting light and second inspecting light to an inside of an optical element recited in claim 5 via an entrance surface of the optical element; a photographing section for (i) photographing the optical element while facing the entrance surface, obtaining a first image by photographing the optical element which is being irradiated with the first inspecting light, and (iii) obtaining a second image by photographing the optical element which is being irradiated with the second inspecting light; a storing section for storing the first image and the second image; and a determining section for determining, from the first image and the second image, presence or absence of a foreign matter in the optical element.

With the arrangement, the photographing section (i) photographs the optical element while facing the entrance surface, (ii) obtains a first image by photographing the optical element which is being irradiated with the first inspecting light, and (iii) obtains a second image by photographing the optical element which is being irradiated with the second inspecting light. The determining section determines, from the first image and the second image, presence or absence of a foreign matter in the optical element.

Specifically, by setting the first inspecting light to have, for example, a wavelength that allows the first inspecting light to be substantially reflected by the antireflection film, and setting the second inspecting light to have, for example, a wavelength that allows the second inspecting light to be substantially transmitted through the antireflection film, in a case where foreign matters are present on an outside of the optical element (in an upper surface of the optical window or above the optical window) and an inside of the optical element, respectively, the foreign matter which is present on the outside of the optical element is shown in a first image of the optical element which first image is captured by irradiating the optical element with the first inspecting light, and the foreign matter which is present on the inside of the optical element is not shown in the first image. Meanwhile, the foreign matters which are present on the outside of the optical element and the inside of the optical element, respectively, are shown in a second image of the optical element which second image is captured by irradiating the optical element with the second inspecting light.

Thus, in a case where a first difference image in which the first image is subtracted from the second image is obtained, only the foreign matter which is present on the inside of the optical element is shown in the first difference image. This makes it possible to inspect presence or absence of a foreign matter in the optical element.

An optical device inspecting method of one or more embodiments of the present invention includes: an illumination step of emitting first inspecting light and second inspecting light to an inside of an optical device recited in claim 1 or 2 via an optical window of the optical device; a photographing step of (i) photographing the optical device while facing the optical window, (ii) obtaining a first image by photographing the optical device which is being irradiated with the first inspecting light, and (iii) obtaining a second image by photographing the optical device which is being irradiated with the second inspecting light; and a determining step of determining, from the first image and the second image, presence or absence of a foreign matter in the optical device.

The arrangement yields a working effect identical to that yielded by the optical device inspecting device.

An optical device inspecting method of one or more embodiments of the present invention includes: an illumination step of emitting first inspecting light and second inspecting light to an inside of an optical device recited in claim 3 or 4 via an optical window of the optical device; a photographing step of (i) photographing the optical device while facing the optical window, (ii) obtaining a first image by photographing the optical device which is being irradiated with the first inspecting light, and (iii) obtaining a second image by photographing the optical device which is being irradiated with the second inspecting light; and a determining step of determining, from the first image and the second image, presence or absence of a foreign matter in the optical device.

The arrangement yields a working effect identical to that yielded by the optical device inspecting device.

An optical device inspecting method of one or more embodiments of the present invention includes: an illumination step of emitting first inspecting light, second inspecting light, and third inspecting light to an inside of an optical device recited in claim 3 or 4 via an optical window of the optical device; a photographing step of (i) photographing the optical device while facing the optical window, obtaining a first image by photographing the optical device which is being irradiated with the first inspecting light, (iii) obtaining a second image by photographing the optical device which is being irradiated with the second inspecting light, and (iv) obtaining a third image by photographing the optical device which is being irradiated with the third inspecting light; and a determining step of determining, from the first image and the second image, presence or absence of a foreign matter in the optical device, and determining, from the second image and the third image, presence or absence of a foreign matter in the optical device.

The arrangement yields a working effect identical to that yielded by the optical device inspecting device.

An optical element inspecting method of one or more embodiments of the present invention includes: an illumination step of emitting first inspecting light and second inspecting light to an inside of an optical element recited in claim 5 via an entrance surface of the optical element; a photographing step of (i) photographing the optical element while facing the entrance surface, (ii) obtaining a first image by photographing the optical element which is being irradiated with the first inspecting light, and (iii) obtaining a second image by photographing the optical element which is being irradiated with the second inspecting light; and a determining step of determining, from the first image and the second image, presence or absence of a foreign matter in the optical element.

The arrangement yields a working effect identical to that yielded by the optical element inspecting device.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 Inspecting device
2 Optical device
3 Optical device
11 Camera (photographing section)
12 Illumination device (illumination section)
13 Control section
14 Storing section
15 Determining section
21 Optical element
22 Housing part
23 Lid part
23a Optical window
24 Window part antireflection film (first antireflection film)
25 Window part antireflection film (first antireflection film)
26 Element part antireflection film (second antireflection film)
31-36 Foreign matter

1.-15. (canceled)

16. An optical device comprising:
a housing part;
an optical element contained in the housing part;
a lid part having an optical window and covering an opening of the housing part; and
a first antireflection film provided in the optical window, the first antireflection film (i) transmitting therethrough signal light used by the optical element, (ii) having a higher reflectance with respect to inspecting light than a reflectance with respect to the signal light, the inspecting light being different in wavelength from the signal light, and (iii) having a lower reflectance with respect to a second inspecting light than a reflectance with respect to a first inspecting light, the first inspecting light and the second inspecting light each serving as the inspecting light.

17. The optical device as set forth in claim 16, wherein the first antireflection film has a reflectance of not more than 1% with respect to the signal light, a reflectance of not less than 80% with respect to the first inspecting light, and a reflectance of not more than 40% with respect to the second inspecting light.

18. The optical device as set forth in claim 16, further comprising:
a second antireflection film provided on an entrance surface of the optical element via which entrance surface the signal light enters the optical element, the second antireflection film having a lower reflectance with respect to a third inspecting light than the reflectance with respect to the second inspecting light, the third inspecting light serving as the inspecting light.

19. The optical device as set forth in claim 18, wherein:
the first antireflection film has a reflectance of not more than 1% with respect to the signal light, a reflectance of not less than 80% with respect to the first inspecting light, and a reflectance of not more than 40% with respect to each of the second inspecting light and the third inspecting light; and
the second antireflection film has a reflectance of not more than 1% with respect to the signal light, a reflectance of not less than 80% with respect to the second inspecting light, and a reflectance of not more than 40% with respect to the third inspecting light.

20. An optical device inspecting device comprising:
an illumination section that emits the first inspecting light and the second inspecting light to an inside of the optical device recited in claim 16 via the optical window of the optical device;
a photographing section that (i) photographs the optical device while facing the optical window, (ii) obtains a first image by photographing the optical device which is being irradiated with the first inspecting light, and (iii) obtains a second image by photographing the optical device which is being irradiated with the second inspecting light;
a storing section that stores the first image and the second image; and
a determining section that determines, from the first image and the second image, presence or absence of a foreign matter in the optical device.

21. The optical device inspecting device as set forth in claim 20, wherein the inspecting light is visible light.

22. An optical device inspecting method comprising:
an illumination step of emitting the first inspecting light and the second inspecting light to an inside of the optical device recited in claim 16 via the optical window of the optical device;
a photographing step of (i) photographing the optical device while facing the optical window, (ii) obtaining a first image by photographing the optical device which is being irradiated with the first inspecting light, and (iii) obtaining a second image by photographing the optical device which is being irradiated with the second inspecting light; and
a determining step of determining, from the first image and the second image, presence or absence of a foreign matter in the optical device.

23. An optical device inspecting device comprising:
an illumination section that emits the first inspecting light and the second inspecting light to an inside of the optical device recited in claim 18 via the optical window of the optical device;
a photographing section that (i) photographs the optical device while facing the optical window, (ii) obtains a first image by photographing the optical device which is being irradiated with the first inspecting light, and (iii) obtains a second image by photographing the optical device which is being irradiated with the second inspecting light;
a storing section that stores the first image and the second image; and
a determining section that determines, from the first image and the second image, presence or absence of a foreign matter in the optical device.

24. An optical device inspecting device comprising:
an illumination section that emits the first inspecting light, the second inspecting light, and the third inspecting light to an inside of the optical device recited in claim 18 via the optical window of the optical device;
a photographing section that (i) photographs the optical device while facing the optical window, (ii) obtains a first image by photographing the optical device which is being irradiated with the first inspecting light, (iii) obtians a second image by photographing the optical device which is being irradiated with the second inspecting light, and (iv) obtains a third image by photographing the optical device which is being irradiated with the third inspecting light;
a storing section that stores the first through third images; and
a determining section that determines, from the first image and the second image, presence or absence of a foreign matter in the optical device, and that determines, from the second image and the third image, presence or absence of a foreign matter in the optical device.

25. An optical device inspecting method comprising:
an illumination step of emitting first inspecting light and second inspecting light to an inside of the optical device recited in claim 18 via the optical window of the optical device;
a photographing step of (i) photographing the optical device while facing the optical window, (ii) obtaining a first image by photographing the optical device which is being irradiated with the first inspecting light, and (iii) obtaining a second image by photographing the optical device which is being irradiated with the second inspecting light; and
a determining step of determining, from the first image and the second image, presence or absence of a foreign matter in the optical device.

26. An optical device inspecting method comprising:
an illumination step of emitting the first inspecting light, the second inspecting light, and the third inspecting light to an inside of the optical device recited in claim 18 via the optical window of the optical device;
a photographing step of (i) photographing the optical device while facing the optical window, (ii) obtaining a first image by photographing the optical device which is being irradiated with the first inspecting light, (iii) obtaining a second image by photographing the optical device which is being irradiated with the second inspecting light, and (iv) obtaining a third image by photographing the optical device which is being irradiated with the third inspecting light; and
a determining step of determining, from the first image and the second image, presence or absence of a foreign matter in the optical device, and determining, from the second image and the third image, presence or absence of a foreign matter in the optical device.

27. An optical element having an entrance surface via which signal light enters the optical element,
said optical element comprising:
an antireflection film provided on the entrance surface,
the antireflection film (i) transmitting therethrough signal light, (ii) having a higher reflectance with respect to inspecting light than a reflectance with respect to the signal light, the inspecting light being different in wavelength from the signal light, and (iii) having a lower reflectance with respect to a second inspecting light than a reflectance with respect to a first inspecting light, the first inspecting light and the second inspecting light each serving as the inspecting light.

28. The optical element as set forth in claim 27, wherein the antireflection film has a reflectance of not more than 1% with respect to the signal light, a reflectance of not less than 80% with respect to the first inspecting light, and a reflectance of not more than 40% with respect to the second inspecting light.

29. An optical element inspecting device comprising:
an illumination section that emits the first inspecting light and the second inspecting light to an inside of the optical element recited in claim 27 via the entrance surface of the optical element;
a photographing section that (i) photographs the optical element while facing the entrance surface, (ii) obtains a first image by photographing the optical element which is being irradiated with the first inspecting light, and (iii) obtains a second image by photographing the optical element which is being irradiated with the second inspecting light;
a storing section that stores the first image and the second image; and
a determining section that determines, from the first image and the second image, presence or absence of a foreign matter in the optical element.

30. An optical element inspecting method comprising:
an illumination step of emitting first inspecting light and second inspecting light to an inside of the optical element recited in claim 27 via the entrance surface of the optical element;
a photographing step of (i) photographing the optical element while facing the entrance surface, (ii) obtaining a first image by photographing the optical element which is being irradiated with the first inspecting light, and (iii) obtaining a second image by photographing the optical element which is being irradiated with the second inspecting light; and
a determining step of determining, from the first image and the second image, presence or absence of a foreign matter in the optical element.
